(19) United States
(12) Patent Application Publication
(10) Pub. No.: US 2007/0107302 A1
(43) Pub. Date: May 17, 2007

(54) Root ball display device

(76) Inventor: Gregory R. Oltman, Barrington, IL (US)

Correspondence Address: MERONI + MERONI, P.O. BOX 309, BARRINGTON, IL, 60011, US

(21) Appl. No.: 11/282,101

(22) Filed: Nov. 17, 2005

(51) Int. Cl. A01G 23/04

(52) U.S. Cl. 47/42

(57) ABSTRACT

A root ball display device comprises a ball-supporting frame and a ball-positioning frame, which frames are joined at elevated junctions. The ball-supporting frame comprises at least three radially extending support members, each of which comprise a proximal support end and a distal support end. The distal support ends extend upwardly from the proximal support ends. The ball-positioning frame comprises at least three positioning members, each of which comprises an upwardly-extending vertex portion and laterally or peripherally adjacent periphery-forming end portions. The periphery-forming end portions are selectively joined to one another to form a common positioning periphery and the distal support ends are joined at the vertex portions for forming at least three ball positioning junctions. The ball-positioning junctions cooperate to position a root ball or similar other spherical body upon a display surface.

### BACKGROUND OF THE INVENTION

1. Field of the Invention

The present invention generally relates to a device for enabling a user to easily position a tree or shrub root ball for display purposes. More particularly, the present invention relates to a certain root ball display framework or assemblage that enables a user to support and position a root ball as may be required.

2. Description of the Prior Art

Moving a tree is a fairly involved process. To ease the tree transplant process, any number of mechanical devices may help the mover to stabilize, position, support, lift, and display the tree, the roots of which are typically bound in a root ball. A number of tree-supportive or root-ball supportive devices are known in the prior art. Several of the more pertinent prior art disclosures relating to tree-supportive or root ball-supportive devices are briefly described hereinafter.

U.S. Pat. No. 3,582,028 ('028 Patent), which issued to Purdy, discloses a Tree Holder. The '028 Patent teaches a tree holder comprising an upwardly opening and elongated container supported by four legs which extend downwardly along and then outwardly and downwardly from the container. The legs are connected to the container near the lower ends thereof by manually adjustable means for changing the locations of the lower ends of said legs relative to the lengthwise extent of the container. Four resiliently flexible elements are secured to the inner side of said container for engaging the butt of a tree extending into the container and for resisting lateral movement of the butt with respect to the container.

U.S. Pat. No. 4,062,148 ('148 Patent), which issued to Edmonds, Jr. et al., discloses Baskets for Receiving Tree Balls and Methods for Use Thereof. The '148 Patent teaches wire tree baskets for receiving tree or shrub balls. The baskets comprise a plurality of spaced apart, circular wire rings of differing diameters in order to taper the basket at an angle of 28 degrees to 32 degrees and a plurality of wire upright loops terminated by bights to give tie-off points for securing the ball within the basket. The basket is welded together with the welds located to reduce the possibility of fractured welds and, further, reduce both the damage to the structural integrity of the basket caused by the fracture of a weld and reduce the potential for damage to adjacent trees caused by the fracture of a weld when balled trees are stacked together. Advantageous methods for using the tree baskets are also disclosed.

U.S. Pat. No. 5,743,508 ('508), which issued to Fiveash, discloses a Tree Stand with Upward/Extending Support Members Forming Part of a Water Basin. The '508 Patent teaches a tree stand having a large water basin and a plurality of extending support sections for supporting a tree. The extending support sections form part of a sidewall of the water basin. The spacing of the extending support sections allows lower limbs of the tree to extend between the support sections and above lower sidewall sections of the water basin. This arrangement allows the stand to be secured closer to the center of gravity of the tree than conventional tree stands and allows a large breadth water basin design.

U.S. Pat. No. 5,791,626 ('626 Patent), which issued to Reese, discloses a Pump Tree Stand. The '626 Patent teaches a tree stand comprising a base defining a tree area, at least one positioning jaw, and at least one securing jaw. The tree stand also includes a pneumatic actuator assembly that actuates the securing jaw in a first direction into the tree area. When the jaws are against the tree they form a clamp that holds the tree upright in the tree area. The tree stand also includes a pneumatic release valve assembly that actuates the securing jaw in a second direction out of the tree area.

U.S. Pat. No. 5,797,579 ('579 Patent), which issued to Krinner, discloses a Tree Stand. The '579 Patent teaches a tree stand featuring a plurality of retaining elements and a single clamping element which acts upon all of the retaining elements via a load transmission element. The load transmission element comprises a flexible, substantially inextensible connecting part having tensile strength which initially moves all of the retaining elements essentially free of a retaining force into contact with the trunk of the tree, and then presses all of the retaining elements against the tree trunk with an essentially identical retaining force.

It will be seen from an inspection of the above-referenced patents and other relevant prior art known to exist that the prior art does not teach a root ball display framework comprising two separate assemblies joined at ball-positioning junctions, which junctions function to support and position a root ball for display purposes. The prior art thus perceives a need for a root ball display framework comprising two separate assemblies joined at ball-positioning junctions, which junctions function to support and position a root ball for display purposes.

### SUMMARY OF THE INVENTION

To achieve the foregoing and other readily apparent objectives, the present invention provides a root ball display assembly designed for supporting and positioning a (tree) root ball structure as placed therein via certain lifting means. Certain junctions intermediate cooperating support and positioning assemblies function to support and position the placed root ball. Notably, root ball structures typically comprise a substantially spherical root ball and often, a substantially linear longitudinal (tree) trunk or shrub axis.

The display device essentially comprises a ball-supporting assembly or frame and a ball-positioning assembly or frame. The ball-supporting assembly essentially comprises at least three radially extending support members, each of which comprise a proximal support end and a distal support end. The distal support ends extend upwardly from the proximal support ends, which proximal support ends are joined or welded at a hub.

The ball-positioning assembly, in turn, comprises at least three circumferentially-extending positioning members, each of which comprises an upwardly-extending vertex portion and laterally or peripherally adjacent periphery-forming end portions. The periphery-forming end portions are selectively joined to one another to form a positioning periphery and the distal support ends are joined at the vertex portions for forming at least three elevated, ball-positioning junctions. Thus, the ball-positioning junctions function to primarily position the root ball of a plant resulting in a supported-positioned plant root ball. The elevated, ball-positioning junctions enable a user to position the spherical root ball such that the longitudinal trunk or shrub axis extends through a central support junction formed at or adjacent the proximal support ends.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of my patent drawings, as follows:

FIG. 1 is a first top perspective view of the preferred embodiment of the root ball display device of the present invention with a root ball structure supported and positioned therein.

FIG. 2 is a second top perspective view of the preferred embodiment of the root ball display device of the present invention.

FIG. 3 is a top plan view of the preferred embodiment of the root ball display device of the present invention.

FIG. 4 is a side plan view of the preferred embodiment of the root ball display device of the present invention as placed upon a substantially planar display surface.

FIG. 5 is a side plan view of a prior art fork lift truck depicted as transporting a root ball.

### DETAILED DESCRIPTION OF THE PREFERRED EMBODIMENT

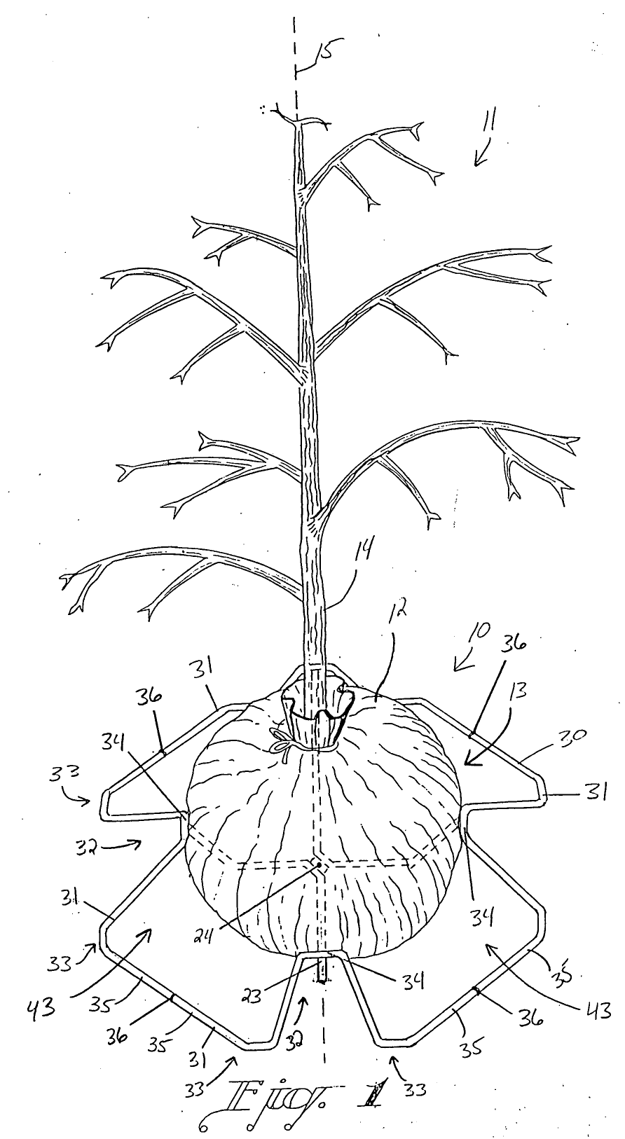

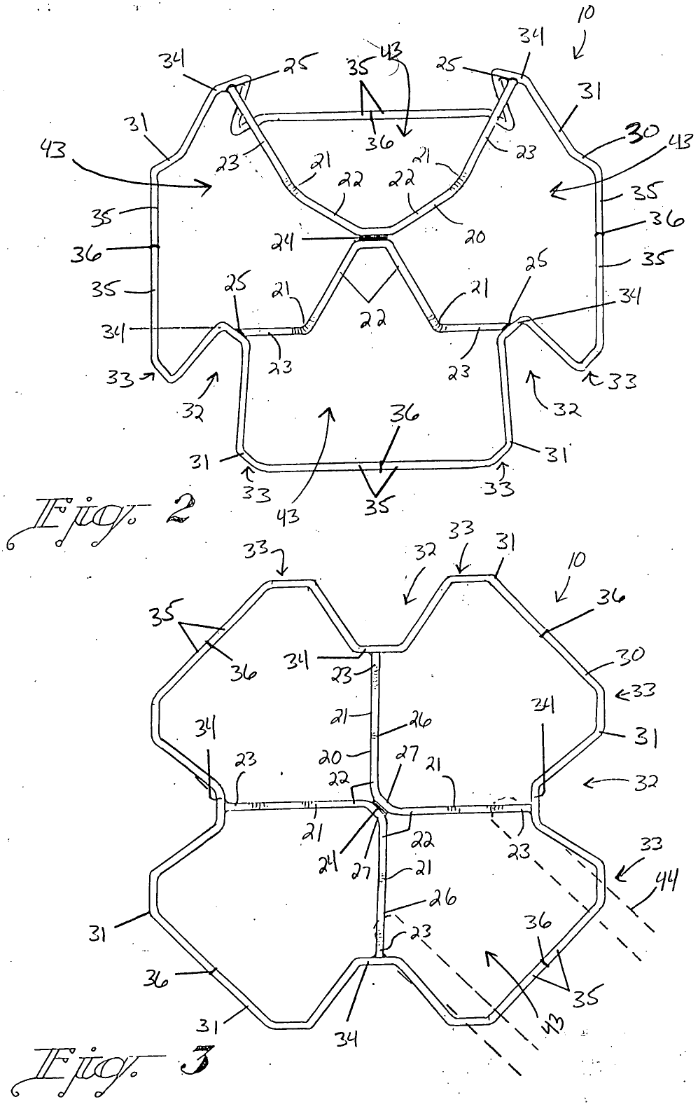

Referring now to the drawings, the preferred embodiment of the present invention concerns a tree root ball display device or assembly 10 as generally illustrated and referenced in FIGS. 1-4, inclusive. The tree root ball display device 10 is designed to interface intermediate common (substantially planar) root ball display surfaces and the burlap (or similar other) sack encasing an uprooted tree or shrub root ball. The tree root ball display device 10 is designed to enable movers of tree root ball structures to more easily display or otherwise displace uprooted trees 11, the roots of which have been balled inside a burlap encasing 12 or similar other structure as generally illustrated and referenced in FIG. 1. In this regard, it will be understood that a typical tree root ball structure comprises a generally spherical root ball 13 and a tree trunk portion 14, which trunk portion 14 generally or typically comprises a longitudinal trunk axis 15 as further referenced in FIG. 1. The display device 10 may thus be said to function as a support and/or positioning assembly for enabling lifted displacement or display of trees, the roots of which have been balled for ease of further transplant. The tree root ball display device 10 preferably comprises a generally X-shaped support assembly or frame 20 preferably constructed of load-supporting rebar or similar other load-bearing material as illustrated and referenced in FIGS. 2-4; and a generally clover-shaped positioning assembly or frame 30 also preferably constructed of load-supporting rebar or similar other load-bearing material as illustrated and referenced in FIGS. 1-4.

The support assembly 20 preferably comprises four (4) radially extending support members 21 as illustrated and referenced in FIGS. 2 and 3. Each support member 21 preferably comprises a proximal support portion 22 as illustrated and referenced in FIGS. 2 and 3; and a distal support portion 23 as illustrated and referenced in FIGS. 1-4. From an inspection of FIGS. 1-3, it will be noted and/or understood that the proximal support portions 22 are joined at a central junction 24 and that the distal support portions 23 preferably extend upwardly from the proximal support portions 22 and terminate at distal termini 25 as referenced in FIG. 2. The support assembly 20 is preferably formed from two V-shaped support members 26 as generally referenced in FIG. 3 wherein each V-shaped support member 26 has a support vertex 27, which support vertices 27 are joined (preferably welded) at the central junction 24.

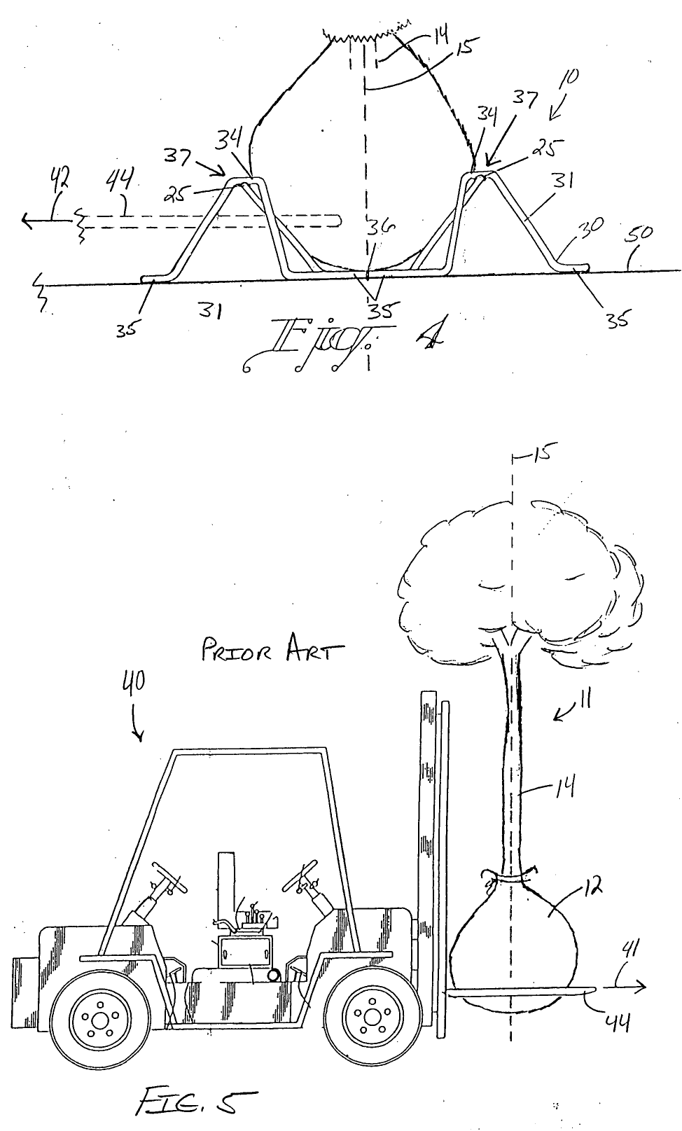

It will be seen from an inspection of the noted figures that the radially-extending support members 21 are preferably substantially equally spaced from one another. The proximal support portions 22 are substantially collinear and collectively coplanar and the distal support portions 23 are each preferably substantially linear. The distal support portions 23 preferably extend upwardly from the proximal support portions at about 45 rotational degrees and the central V-shaped portions 32 preferably extend upwardly from the outer V-shaped portions at about 45 rotational degrees as may be understood from a general inspection of FIG. 4. Preferably, the periphery-forming portions 35 adjacent the peripheral termini 36 are substantially collinear as may be seen from a general inspection of FIGS. 1-3, which collinear periphery-forming portions are further preferably substantially coplanar.

From an inspection of FIGS. 1 and 3, it may be most readily understood that positioning assembly 30 is preferably or generally (four-leaf) clover-shaped. The positioning assembly 30 preferably comprises four (4) roughly W-shaped, circumferentially-extending positioning members 31 as generally illustrated and referenced in FIGS. 1-4. Each positioning member 31 comprises a central V-shaped portion 32 and two outer V-shaped portions 33 (the portions 32 and 33 sharing a common leg) as further referenced in FIGS. 1-3. The V-shaped portions 32 preferably extend upwardly from the outer V-shaped portions 33 and each V-shaped portion has a (ball or sphere) positioning vertex 34 as specifically illustrated positioning ball-like or spherical structure in FIG. 1 and as further generally referenced in FIGS.2-4. The outer V-shaped portions 33 each comprise a periphery-forming (leg) portion 35 as referenced in FIGS. 1-4. The periphery-forming portions 35 each have a peripheral terminus (not specifically referenced), which termini are joined (preferably welded) to one another (as at joints 36 referenced in FIGS. 1-3) thus forming a common positioning periphery perhaps as most clearly depicted in FIG. 3.

The distal termini 25 of support assembly 20 are then joined (preferably welded) at the positioning vertices 34 for forming four (4) lift junctions 37, two (2) of which are clearly depicted in FIG. 4. From an inspection of FIGS. 3 and 4, it will be seen that lift members 16 may be raised as referenced at 38 to make contact with lift junctions 37 so as to lift tree root ball display assembly 10 via certain forces (as depicted at vectors 39). Thus, it will be understood that the support assembly 20 is primarily designed to support a tree root ball placed thereupon (the support assembly 20 being proximal to the common positioning periphery and the weight of the tree root ball or similar other spherical member being directed downward). Further, the support and positioning assemblies 20 and 30 are each designed to position the placed tree root ball. In this regard, it will be understood that the supportive support assembly 20 “positions” the tree root ball vertically as a support structure and further positions the tree root ball at the distal support members 23, the contact interfacing having normal force vectors directed toward the longitudinal trunk axis 15 (or similar other axis) as directed against the root ball 13. It will thus be understood that the placed tree root ball may be thought of as being “supported-positioned”. The lift junctions 37 thus enable the user to liftedly displace or otherwise display the “supported-positioned” tree root ball.

It will thus be understood that the present invention discloses a tree root ball display assembly 10 for supporting, positioning, lifting, and displaying a tree root ball structure. The tree root ball structure comprises a substantially spherical root ball and often, a substantially linear tree trunk portion, the tree trunk portion having a longitudinal trunk axis 15. The display device 10 comprises a ball-supporting assembly (such as support assembly 20) and a ball-positioning assembly (such as positioning assembly 30), which ball-supporting assembly must essentially comprise at least three radially extending support members, each of which comprise a proximal support end and a distal support end. The distal support ends extend upwardly from the proximal support ends (joined or welded at a hub).

The ball-positioning assembly, in turn, comprises at least three circumferentially-extending positioning members, each of which comprise an upwardly-extending vertex portion (such as central V-shaped portions 32) and two periphery-forming end portions (such as periphery-forming portions 35). The periphery-forming end portions are joined to one another to form a positioning periphery and the distal support ends are joined at the vertex portions for forming at least three elevated, lift-enabling junctions (such as lift junctions 37). Thus, the ball-supporting assembly functions to primarily support a tree root ball as placed thereupon and the ball-positioning assembly functions to primarily position the supported tree root ball resulting in supported-positioned tree root ball. The elevated, lift-enabling junctions enable a user to lift and display the supported-positioned tree root ball structure. Notably, the ball-positioning assembly enables the user to position the spherical root ball such that the longitudinal trunk axis extends through central support junction 24 formed at or adjacent the proximal support ends.

It is contemplated that all frame work may be constructed from ½ inch concrete reinforcing rod or rebar. This type of material results in a manually maneuverable device (weighing on the order of 5-10 pounds) and functions to receive root balls having diameters on the order of 28-36 inches (which typically weigh in the range of 600-1600 pounds). Conceivably, however, the construction could be adjusted to receive root balls having diameters on the order of 38-42 inches (which typically weigh on the order of 1800 pounds). Further, the number of welds is fairly limited given the preferred design. In this regard, it is contemplated that as few as six (6) welds may be required to assembly the root ball display device (if, for example, the common outer periphery were formed of a single member joined at the ends by a welded junction having the specified structures intermediate the two ends).

Thus, while the above description contains much specificity, this specificity should not be construed as limitations on the scope of the invention, but rather as an exemplification of the invention. For example, as is described hereinabove, it is contemplated that the present invention essentially discloses a spherical member display device or interface comprising a member-supporting frame and a member-positioning frame. The member-supporting frame comprises at least three radially-extending support members, each of which comprises a proximal support end and a distal support end.

The member-positioning frame comprises at least three circumferentially-extending positioning members, each of which comprise an upwardly-extending central portion (such as central V-shaped portions 32) and two adjacent periphery-forming end portions selectively joined to one another for forming a positioning periphery. In this last regard, it should be noted that the circumferentially-extending members may be formed from a single piece of material (having two ends) and formed so as to include at least three upwardly-extending central portions. The two ends would thus be preferably welded so as to form a continuous positioning periphery. The selectively joined periphery-forming end portions may thus be joined by a weld or as an integrally joined or integrally formed, continuous load-bearing member. The distal support ends are joined at the central portions for forming at least three lift-enabling junctions. The member-supporting frame may thus support and position a spherical member placed thereupon (the upwardly extending tri-support member configuration effectively operating to center a spherical member the weight of which is directed downward). The member-positioning frame further positions the supported spherical member.

I claim:

1. A tree root ball display device, the display device for supporting and positioning a tree root ball, the display device comprising:
an X-shaped support assembly, the support assembly comprising four radially extending support members, each support member comprising a proximal support portion and a distal support portion, the proximal support portions being joined at a central junction, the distal support portions extending upwardly from the proximal support portions and terminating at distal termini;
a clover-shaped positioning assembly, the positioning assembly comprising four W-shaped, circumferentially-extending positioning members, each positioning member comprising a central V-shaped portion and two outer V-shaped portions, the central V-shaped portions extending upwardly from the outer V-shaped portions, the central V-shaped portions each having a positioning vertex, the outer V-shaped portions each comprising a periphery-forming portion, the periphery-forming portions each having a peripheral terminus, the peripheral termini being joined to one another thus forming a common periphery, the distal termini being joined at the positioning vertices thus forming four assembly junctions, the support and positioning assemblies for positioning a tree root ball placed thereupon, the placed tree root ball thus being supported-positioned via the assembly junctions.

2. The display device of claim 1 wherein the support assembly is formed from two V-shaped support members, each V-shaped support members having a support vertex, the support vertices being joined at the central junction.

3. The display device of claim 2 wherein the radially-extending support members are substantially equally spaced from one another.

4. The display device of claim 3 wherein the proximal support portions are substantially coplanar and the distal support portions are each substantially linear.

5. The display device of claim 4 wherein the distal support portions extend upwardly from the proximal support members at about 45 rotational degrees and the central V-shaped portions extending upwardly from the outer V-shaped portions positioning vertices at about 45 rotational degrees.

6. The display device of claim 5 wherein the periphery-forming portions adjacent the peripheral termini are substantially collinear.

7. The display device of claim 6 wherein the periphery-forming portions are substantially coplanar, the coplanar periphery-forming portions being coplanar.

8. The display device of claim 7 wherein the periphery-forming portions are substantially coplanar with the proximal support portions for displaying the tree root ball upon a planar support surface.

9. A plant root ball display assembly for supporting and positioning a plant root ball structure, the plant root ball structure comprising a substantially spherical root ball and a trunk portion, the trunk portion having a longitudinal trunk axis, the display assembly comprising a ball-supporting assembly and a ball-positioning assembly, the ball-supporting assembly comprising at least three radially extending support members, each support member comprising a proximal support end and a distal support end, the distal support ends extending upwardly from the proximal support ends, the ball-positioning assembly comprising at least three circumferentially-extending positioning members, each positioning member comprising an upwardly-extending vertex portion and two periphery-forming end portions, the periphery-forming end portions being joined to one another for forming a positioning periphery, the distal support ends being joined at the vertex portions for forming at least three elevated, positioning junctions, the ball-supporting and positioning assemblies cooperatively positioning a plant root ball placed thereupon, the plant root ball thus being supported-positioned via the positioning junctions.

10. The display device of claim 8 wherein the ball-positioning assembly enables a user to position the spherical root ball such that the longitudinal trunk axis extends through a central support junction formed at the proximal support ends.

11. The display device of claim 8 wherein the radially-extending support members are substantially equally spaced from one another.

12. The display device of claim 8 wherein the support members each comprise a proximal support portion and a distal support portion, the proximal support portions being substantially coplanar and the distal support portions being substantially linear.

13. The display of claim 12 wherein the distal support portions extend upwardly from the proximal support portions at about 45 rotational degrees.

14. The display device of claim 12 wherein the periphery-forming portions are substantially coplanar with the proximal support portions for displaying the plant root ball upon a substantially planar support surface.

15. A spherical member display structure, the spherical member display structure comprising a member-supporting frame and a member-positioning frame, the member-supporting frame comprising at least three radially extending support members, each support member comprising a proximal support end and a distal support end, the distal support ends extending upwardly from the proximal support ends, the member-positioning frame comprising at least three circumferentially-extending positioning members, each positioning member comprising an upwardly-extending central portion and adjacent periphery-forming end portions, the periphery-forming end portions selectively joined to one another for forming a positioning periphery, the distal support ends being joined at the central portions for forming at least three assembly junctions, the assembly junctions for positioning a spherical member placed thereupon.

16. The display structure of claim 15 wherein the radially-extending support members are substantially equally spaced from one another.

17. The display structure of claim 15 wherein the support members each comprise a proximal support portion and a distal support portion, the proximal support portions being substantially coplanar and the distal support portions being substantially linear.

18. The display structure of claim 17 wherein the distal support portions extend upwardly from the proximal support portions at about 45 rotational degrees.

19. The display structure of claim 15 wherein the periphery-forming portions are substantially coplanar.

20. The display structure of claim 17 wherein the periphery-forming portions are substantially coplanar with the proximal support portions for displaying the spherical member upon a substantially planar support surface.
